(19) United States
(12) Patent Application Publication
(10) Pub. No.: US 2024/0369350 A1
(43) Pub. Date: Nov. 7, 2024

(54) METHOD AND DEVICE FOR DETERMINING A TRANSMISSION OF AN OBJECT FOR ELECTROMAGNETIC RADIATION

(71) Applicant: HELMUT FISCHER GMBH INSTITUT FÜR ELEKTRONIK UND MESSTECHNIK, Sindelfingen (DE)

(72) Inventors: Rüdiger Mästle, Böblingen (DE); Niklas Müller, Kirchheim am Neckar (DE)

(21) Appl. No.: 18/682,059

(22) PCT Filed: Aug. 8, 2022
(86) PCT No.: PCT/EP2022/072208

§ 371 Date: Feb. 7, 2024

(30) Foreign Application Priority Data
Aug. 13, 2021 (DE) 102021121099.2

(51) Int. Cl. G01B 11/06; G01N 21/3586; G01N 21/59

(52) U.S. Cl. CPC G01B 11/0616; G01N 21/3586; G01N 21/59

(57) ABSTRACT

A method, for example a computer-implemented method, includes determining a transmission of an object, for example a substrate, for electromagnetic radiation in a frequency range between 30 gigahertz (GHz) and 200 GHz. The method includes determining a thickness of the substrate on at least one location of the object, determining the transmission by using a first model characterizing the transmission of the object for the electromagnetic radiation, based at least on the thickness of the substrate.

### CROSS REFERENCE TO RELATED APPLICATIONS

The present application claims priority as a national stage application under 35 U.S.C. 371 to PCT Application No. PCT/EP2022/072208 filed on Aug. 8, 2022, which claims priority to German (DE) application Ser. No. 10/202,1121099.2 filed on Aug. 13, 2021, both of which are incorporated by reference herein.

### FIELD

The disclosure relates to a method and device for determining a transmission of an object for electromagnetic radiation.

### SUMMARY

Exemplary embodiments relate to a method, for example a computer-implemented method, for determining a transmission of an object, for example a substrate, for electromagnetic radiation in a frequency range between 30 gigahertz (GHz) and 200 GHz, comprising: determining a thickness of the substrate for at least one location of the object, determining the transmission using a first model characterizing the transmission of the object for the electromagnetic radiation based at least on the thickness of the substrate. Thus, in some exemplary embodiments, an efficient determination of the transmission of the object for the electromagnetic radiation is enabled.

In other exemplary embodiments, the transmission can also be determined for frequencies above 200 GHz.

In further exemplary embodiments, it is provided that the at least one layer is arranged on the substrate, for example on a first surface of the substrate, the method comprising: determining a layer thickness of the at least one layer, for example some layers, for example all layers, of the at least one layer, for example at least one location of the object, and determining the transmission by means of the first model and/or at least one further model characterizing the transmission of the object for the electromagnetic radiation, based at least on the thickness of the substrate and on the layer thickness of the at least one layer.

In further exemplary embodiments, the substrate may comprise, for example, a plastic material, such as polypropylene. In further exemplary embodiments, the at least one layer on the substrate may be a paint layer and/or primer or the like.

In further exemplary embodiments, the object is, for example, a component for a vehicle, for example a motor vehicle, for example a body part, for example a body part to be painted or coated.

In further exemplary embodiments, the thickness of the substrate is at least ten times greater than the layer thickness of the at least one layer, for example at least fifty times greater, wherein, for example, a thickness of the substrate is greater than or equal to 1 millimeter, mm.

In further exemplary embodiments, it is provided that the electromagnetic radiation has frequencies between 20 GHz and 90 GHz, for example between 60 GHz and 85 GHZ.

In further exemplary embodiments, it is provided that the electromagnetic radiation has frequencies in a radar frequency range, for example for radar applications in the automotive sector.

In further exemplary embodiments, it is provided that the method comprises at least one of the following elements: a) determining the thickness of the substrate, for example for one or more measuring points, by means of at least one measurement based on terahertz radiation (“THz-based measurement”), b) determining the thickness of the substrate, for example for one or more measuring points, by means of at least one measurement that is not based on terahertz radiation, for example based on an optical and/or a mechanical measuring principle, c) determining the layer thickness of the at least one layer, for example for one or more measuring points, by means of at least one measurement based on terahertz radiation, d) determining the thickness of the substrate and the layer thickness of the at least one layer by means of at least one measurement based on terahertz radiation, for example common to the substrate and the at least one layer, e) determining the thickness of the substrate, for example for one or more measuring points, based on structural data, for example CAD data, of the object, f) determining the thickness of the substrate and/or the at least one layer thickness, for example for one or more measuring points, based on existing thickness or layer thickness values, for example of at least one other measuring point.

In further exemplary embodiments, it is provided that the method comprises at least one of the following elements: a) performing at least one measurement based on reflection of the terahertz radiation, b) performing at least one measurement based on transmission of the terahertz radiation, wherein, for example, the terahertz radiation has a frequency range between 0.05 terahertz, THz, and 10 THz, for example between 0.1 THz and 6 THz.

In further exemplary embodiments, the transmission of the object for the electromagnetic radiation in the radar frequency range can, for example, be efficiently determined based on at least one THz-based reflection measurement. In further exemplary embodiments, the at least one THz-based reflectance measurement can optionally additionally be used for a determination of the thickness of the substrate and/or the at least one layer. In other words, in further exemplary embodiments, based on at least one THz-based reflection measurement, both thicknesses or layer thicknesses of the object can be determined, as well as a transmission of the object in a frequency range that may be at least partially different from the frequency range of the THz radiation, for example a radar frequency range.

In further exemplary embodiments, it is provided that the method comprises: providing material data characterizing a propagation of the electromagnetic radiation in the object, for example in the substrate and/or in the at least one layer, wherein, for example, the material data comprises at least one of the following elements: a) dispersion relations, for example comprising a refractive index, for example frequency-dependent and/or frequency-independent, and/or an absorption index, for example frequency-dependent and/or frequency-independent, b) surface properties, and, optionally, using the material data, for example for determining the transmission.

In further exemplary embodiments, it is also possible to use e.g. frequency-dependent quantities (e.g. refractive index and/or absorption index) at least for some materials, and to use e.g. frequency-independent quantities (e.g. refractive index and/or absorption index) for some other materials.

In further exemplary embodiments, it is provided that the method comprises at least one of the following elements: a) providing the first model, for example as an object model, which characterizes, for example, the transmission based on the thickness of the substrate and/or based on material data associated with the object, for example the substrate, b) providing the at least one further model, for example as an object model, which characterizes, for example, the transmission based on the thickness of the substrate and the layer thickness of the at least one layer and/or based on material data associated with the object, for example the substrate and/or the at least one layer.

In further exemplary embodiments, it is provided that the method comprises: taking into account a dependence of a propagation of the terahertz radiation in the object on at least one of the following criteria: a) distance of a transmitter and/or receiver for the terahertz radiation from the object, for example from a surface of the substrate, b) thickness of the substrate and/or layer thickness of the at least one layer, c) angle between a main beam direction of the terahertz radiation and a surface normal of at least one, for example outer and/or inner, interface of the object and/or of the substrate.

In further exemplary embodiments, it can also be taken into account that, for example, a rear side of the substrate has a different angle to the main beam direction than the front side (e.g. non-planar substrate). This can be implemented, for example, by taking into account an angle between the main beam direction of the terahertz radiation and a surface normal of the rear side of the object.

In further exemplary embodiments, it is provided that the taking into account comprises: characterizing, by means of at least one layer model, a propagation of the terahertz radiation in the region of at least one interface between two adjacent media in a spatial region associated with the object, wherein the at least one layer model comprises a term characterizing the THz radiation which is dependent on at least one of the following elements: a) frequency of the terahertz radiation, b) spatial extent and/or position of at least one of the two adjacent media, for example along a first spatial direction, wherein, for example, A) the at least one layer model characterizes at least one reflection and/or transmission of the terahertz radiation at the at least one interface between the at least two media, wherein, for example, the at least one layer model characterizes a plurality of reflections and/or transmissions of the terahertz radiation at least two interfaces between different media, wherein, for example, the term characterizing the terahertz radiation has a different value for each of the at least two interfaces, wherein, for example, B) the at least one layer model characterizes one or the plurality of reflections and/or transmissions of the terahertz radiation at a plurality of interfaces between in each case two media adjoining one another in the spatial region by means of a coherent superposition function, the term being provided as a weighting factor, for example a weighting factor other than one, for at least some components of the coherent superposition function.

In further exemplary embodiments, it is provided that the at least one layer model comprises a first component which characterizes a sample measurement on the object in reflection arrangement or transmission arrangement by means of the terahertz radiation, wherein the first component is characterizable in a frequency space, for example for the reflection arrangement, based on the following equation:

$${F}_{S} ( ω , x , y , z ) = {I}_{0} ( ω , x , y , z ) exp [ - i \frac{ω}{{c}_{0}} [ 2 ( L + Δ D ) ( {n}_{A} - i {ϵ}_{A} ) ] + i {ϕ}_{0} ( ω , x , y , z ) ] \cdot ( {t}_{A 1} {t}_{1 A} {\sum }_{R = 0}^{∞} {r}_{1 S}^{R + 1} {r}_{1 A}^{R} G ( D , R , ω , x , y , z , α , β , Ω ) exp [ - i \frac{ω}{{c}_{0}} ( 2 R + 2 ) D ( n - i ϵ ) ] + {r}_{A 1} ) ,$$

where F_{S} (ω, x, y, z) characterizes, for example, a frequency-dependent field strength of a sample signal, wherein ω characterizes a circular frequency associated with a frequency of the terahertz radiation, wherein x characterizes a first spatial coordinate, wherein y characterizes a second spatial coordinate, wherein z characterizing a third spatial coordinate, wherein I₀(ω, x, y, z) characterizes a field strength, for example frequency-dependent, of the terahertz radiation at an emitter generating the terahertz radiation, wherein exp [ ] characterizes an exponential function, wherein i characterizes the imaginary unit, wherein c₀ characterizes the vacuum light velocity, wherein L characterizing a distance between a terahertz device (e.g. comprising an emitter and/or receiver for the THz radiation) and a reference object, wherein ΔD characterizing an offset between the reference object and the object, wherein n_{A} characterizing a refractive index of a medium present in the spatial region, for example air, wherein ϵ_{A} characterizing an extinction coefficient of the medium present in the spatial region, wherein ϕ₀(ω, x, y, z) characterizing a phase, for example frequency-dependent, of the terahertz radiation at the emitter generating the terahertz radiation, wherein t_{A1} characterizing a transmission coefficient at an interface between the medium present in the spatial region and a layer characterizing a surface of the object, wherein t_{1A} characterizes a transmission coefficient at the interface between the layer characterizing the surface of the object and the medium present in the spatial region, wherein r_{1S} characterizes a reflection coefficient at an interface between a layer of the object and a substrate, wherein R characterizing a reflection index characterizing a number and/or sequence of reflections and/or transmissions of the terahertz radiation, wherein r_{1A} characterizing a reflection coefficient at the interface between the layer characterizing the surface of the object and the medium present in the spatial region, wherein G(D, R, ω, x, y, z, α, β, Ω) characterizes the term (T) characterizing the THz radiation or a or the weighting factor, which in further exemplary embodiments can also be understood, for example, as a correction term in models for plane waves, wherein D characterizes a layer thickness of a layer, wherein n characterizes a refractive index of a layer, wherein ϵ characterizes an extinction coefficient of a layer, where r_{A1} characterizes a reflection coefficient at an interface between the medium present in the spatial region and a layer characterizing a surface of the object, wherein α and/or β optionally characterizing an angular orientation of the terahertz device relative to the object, wherein Ω optionally characterizing properties of a surface of the object, wherein the properties of the surface of the object comprise, for example, at least one of the following elements: a) shape of the surface, for example curvature, b) roughness of the surface.

In further exemplary embodiments, it is provided that the at least one layer model comprises a second component which characterizes a reference measurement on a reference object in reflection arrangement or transmission arrangement by means of the terahertz radiation, wherein the second component can be characterized in the frequency space, for example for the reflection arrangement, based on the following equation:

$$F ( ω , x , y , z ) = {I}_{0} ( ω , x , y , z ) exp [ - i \frac{ω}{{c}_{0}} ( 2 L ) ( {n}_{A} - i {ϵ}_{A} ) + i {ϕ}_{0} ( ω , x , y , z ) ] \cdot {r}_{AM}$$

where F(ω, x, y, z) characterizes a, for example frequency-dependent, field strength of a reference signal, wherein r_{AM} characterizes a reflection coefficient at an interface between the medium present in the spatial region and a surface of the reference object.

In further exemplary embodiments, it is provided that the at least one layer model, for example for a reflection arrangement, can be characterized in a or the frequency space, for example based on the following equation:

$$H ( ω ) = exp [ - i \frac{ω}{{c}_{0}} ( 2 Δ D ) ( {n}_{A} - i {ϵ}_{A} ) ] \cdot ( {t}_{A 1} {t}_{1 A} {\sum }_{R = 0}^{∞} {r}_{1 S}^{R + 1} {r}_{1 A}^{R} G ( D , R , ω , x , y , z , α , β , Ω ) exp [ - i \frac{ω}{{c}_{0}} ( 2 R + 2 ) D ( n - i ϵ ) ] + {r}_{A 1} ) / {r}_{AM}$$

wherein H(ω) characterizes a transfer function, for example related to a reference measurement, of the terahertz radiation.

In further exemplary embodiments, it is provided that the term is dependent on at least one of the following elements as an alternative or in addition to a) the frequency of the terahertz radiation, and/or b) the spatial extent and/or position of at least one of the two adjacent media, for example along a first spatial direction: c) reflection index characterizing a number and sequence of reflections and/or transmissions, d) angular orientation of the terahertz device with respect to the object and/or the reference object, e) distance, for example between the at least one terahertz device and/or the at least one object, f) property of a surface of the at least one object, for example a shape of the surface and/or a roughness of the surface.

In further exemplary embodiments, it is provided that the at least one layer model, for example by means of the term or the weighting factor, models a distance-dependent spectral change of a transfer function of the terahertz radiation as a distance-dependent or depth-dependent attenuation and/or amplification.

In further exemplary embodiments, it is provided that the at least one layer model, for example by means of the term or the weighting factor, models an angle-dependent spectral change of a transfer function of the terahertz radiation as angle-dependent attenuation and/or amplification.

In further exemplary embodiments, it is provided that the at least one layer model models, for example by means of the term or the weighting factor, a spectral change of a transfer function of the terahertz radiation based on at least one property of a or the surface of the at least one object, for example based on a shape of the surface and/or a roughness of the surface.

In further exemplary embodiments, it is provided that the at least one layer model comprises an object comprising a plurality of layers of different media, wherein, for example, the model characterizes at least one of the following elements: a) reflections and/or transmissions of the terahertz radiation in the object, for example between adjacent layers, b) multiple reflections and/or multiple transmissions of the terahertz radiation in the object, c) virtual reflection points and/or virtual transmission points, for example characterizable by a reflection index, in the object, d) coherent superposition of the various reflections and/or transmissions of the terahertz radiation in the object.

In further exemplary embodiments, it is provided that the method further comprises: determining the term and/or individual values of the term based on an optical model of a system characterizing the terahertz device and the object or reference object, and, optionally, an environmental medium surrounding the terahertz device and the object or reference object, wherein, for example, the optical model characterizes a spectral transfer function of the terahertz radiation, for example within the system.

In further exemplary embodiments, it is provided that the method further comprises: determining the term and/or individual values of the term based on an optical model of a system characterizing the terahertz device and the object or reference object, and, optionally, an ambient medium surrounding the terahertz device and the object or reference object, wherein the optical model characterizes an amplitude and phase over the spatial extent of the terahertz radiation, for example within the system.

In further exemplary embodiments, the optical model takes into account diffraction effects of the terahertz radiation.

In further exemplary embodiments, it is provided that the method further comprises: determining the optical model based on modeling by means of a) ray tracing and/or b) a diffraction-theoretical description, e.g. by means of a diffraction integral, e.g. Collins integral, and/or c) a parametric calculation with model function, and, optionally, calibrating the optical model, wherein, for example, the determining and/or calibrating of the optical model is performed with frequency resolution.

In further exemplary embodiments, it is provided that the method further comprises: calibrating the optical model, for example with respect to the spectral transfer function and/or spatial amplitude and/or phase, based on at least one of the following elements: a) angle between an optical axis of the terahertz device and a surface normal of the object or reference object, b) distance between the terahertz device and a surface of the object or reference object, c) property of one or the surface of the at least one object or reference object, for example of the reference object, for example based on a shape, for example curvature, of the surface and/or a roughness of the surface, d) frequency of the terahertz radiation.

In further exemplary embodiments, it is provided that the method comprises: determining a first, for example time-resolved, THz signal, wherein the method further comprises: determining, based on the first THz signal, for example by means of at least one temporal windowing, a first partial signal, wherein, for example, the first partial signal characterizes THz radiation which a) has been reflected at a first interface between the at least one layer and the substrate, for example the first surface of the substrate (and/or at least one further interface, for example between two adjacent layers), for example b) but has not been reflected at a second surface of the substrate opposite the first surface of the substrate.

In further exemplary embodiments, it is provided that the method comprises: determining a second partial signal, wherein, for example, the second partial signal characterizes THz radiation that has been reflected, for example, inter alia, at a second interface opposite the first interface, wherein, for example, a second surface of the substrate opposite the first surface of the substrate forms the second interface.

In further exemplary embodiments, it is provided that the method comprises: determining the layer thickness of the at least one layer based on the first partial signal, for example using a or the first layer model for the at least one layer.

In further exemplary embodiments, it is provided that the method comprises: determining the thickness of the substrate based on the first THz signal, wherein, for example, determining the thickness of the substrate based on the first THz signal comprises at least one of the following elements: a) determining the thickness of the substrate based on a high-frequency portion of a transfer function associated with the first THz signal, b) determining the thickness of the substrate based on a phase, for example linear, which characterizes a difference of a phase of a transfer function associated with the second partial signal and a phase of a transfer function associated with the first partial signal.

In further exemplary embodiments, it is provided that the method comprises: determining the layer thickness of the at least one layer and the thickness of the substrate based on the first THz signal, for example using a second layer model for the substrate with the at least one layer.

In further exemplary embodiments, it is provided that the method comprises: determining the transmittance for at least one measuring point of the object, and/or determining the transmittance for several measuring points of the object.

In further exemplary embodiments, it is provided that the method comprises: determining whether a complexity of the object, for example a complexity of a shape of the object, exceeds a predeterminable limit value, and, optionally, for example if the complexity does not exceed the predeterminable limit value, determining the transmission based on a plurality of measurement points, for example based on averaging with respect to the plurality of measurement points.

In further exemplary embodiments, it is provided that the method comprises: using, for example if the complexity exceeds the predeterminable limit value, a design model, for example CAD model, of the object, wherein the design model characterizes, for example, at least one surface structure and/or coating of the object, and, optionally, adapting the design model to a measured substrate thickness and/or coating thickness, for example for one or more measurement points.

In further exemplary embodiments, it is provided that the method comprises: modeling a transmitter emitting the electromagnetic radiation, for example with respect to at least one of the following elements: a) position, b) size, c) beam angle or characteristic, d) beam intensity.

In further exemplary embodiments, it is provided that the method comprises: modeling a receiver receiving the electromagnetic radiation, for example with respect to at least one of the following elements: a) position, b) size, c) characteristic.

In further exemplary embodiments, it is provided that the method comprises providing an overall model for the transmission based on an object model for the object, and on at least one further model, wherein the at least one further model characterizes a transmitter and/or a receiver of the electromagnetic radiation, configuring the overall model based on the transmission determined for at least one measuring point, for example several measuring points, of the object, determined for at least one measuring point, for example several measuring points of the object, and/or based on determined layer thicknesses and/or substrate thicknesses and/or based on at least one, for example frequency-dependent and/or constant, refractive index and/or on at least one, for example frequency-dependent and/or constant, absorption index, evaluating the overall model, and, optionally, adapting at least one component of the overall model.

In further exemplary embodiments, it is provided that the method comprises: determining a received intensity of the electromagnetic radiation, wherein, for example, the evaluating and/or the determining is performed based on a ray tracing method and/or a, for example other, calculation method for the propagation of the electromagnetic radiation.

Further exemplary embodiments relate to a device for carrying out the method according to the embodiments.

In further exemplary embodiments, it is provided that the device has at least one of the following elements: a) an interface part to at least one THz measurement system which is designed to transmit and/or receive terahertz radiation, for example the THz measurement system having at least one transmitter for the terahertz radiation and/or a receiver for the terahertz radiation and/or a transceiver for the terahertz radiation, b) a positioning system, for example a robot, e.g. industrial robot.

Further exemplary embodiments relate to a computer readable storage medium comprising instructions which, when executed by a computer, cause the computer to perform the method according to the embodiments.

Further exemplary embodiments relate to a computer program comprising instructions which, when the program is executed by a computer, cause the computer to perform the method according to the embodiments.

Further exemplary embodiments relate to a data carrier signal that transmits and/or characterizes the computer program according to the embodiments.

Further exemplary embodiments relate to a use of the method according to the embodiments and/or the device according to the embodiments and/or the computer-readable storage medium according to the embodiments and/or the computer program according to the embodiments and/or the data carrier signal according to the embodiments for at least one of the following elements: a) determining a transmission of an object in a radar frequency range based on a thickness measurement of at least one component of the object, b) determining a transmission of an object in a radar frequency range based on a thickness measurement of at least one component of the object based on the use of THz radiation, c) determining a transmission of an object in a radar frequency range based on reflection measurements using THz radiation, d) adapting a design model, for example a CAD model, of the object, e) determining a transmission of an object in a radar frequency range and of a thickness of the substrate and/or at least one layer thickness of the at least one layer based on at least one THz-based measurement, for example based on at least one, for example the same or joint, THz-based measurement.

Further features, possible applications and advantages result from the following description of exemplary embodiments, which are shown in the figures of the drawing. All of the features described or illustrated form the subject matter of exemplary embodiments on their own or in any combination, irrespective of their summary in the claims or their relationship to one another and irrespective of their formulation or illustration in the description or in the drawing.

### BRIEF DESCRIPTION OF THE DRAWINGS

FIG. 1 schematically illustrates a simplified flow diagram for determining a transmission of an object for electromagnetic radiation according to exemplary embodiments.

FIG. 2 schematically illustrates a simplified block diagram of the object including at least a substrate according to exemplary embodiments.

FIG. 3 schematically illustrates a simplified block diagram of the object including at least the substrate and at least one layer according to exemplary embodiments.

FIG. 4 schematically illustrates a simplified flow diagram for determining a transmission of the object including at least the substrate and that least one layer according to exemplary embodiments.

FIG. 5 schematically illustrates a simplified flow diagram of one or more steps that may be performed for determining a transmission of the object according to exemplary embodiments.

FIG. 6 schematically illustrates a simplified block diagram of one or more measuring points of the object according to exemplary embodiments.

FIG. 7 schematically illustrates a simplified flow diagram of performing a measurement using terahertz radiation according to exemplary embodiments.

FIG. 8 schematically illustrates a simplified flow diagram for determining a transmission of the object using material data according to exemplary embodiments.

FIG. 9 schematically illustrates a simplified flow diagram for determining a transmission of the object using material data according to exemplary embodiments.

FIG. 10 schematically illustrates a simplified flow diagram for determining a dependence of a propagation of the terahertz radiation in the object according to exemplary embodiments.

FIG. 11 schematically illustrates a simplified block diagram of a THz device according to exemplary embodiments.

FIG. 12 schematically illustrates a simplified block diagram of an α a between a main beam direction R of the terahertz radiation TS and a surface normal ON of at least one, for example outer and/or inner, interface of the object and/or of the substrate according to exemplary embodiments.

FIG. 13 schematically illustrates a simplified block diagram of at least one interface between two adjacent media in a spatial region associated with the object according to exemplary embodiments.

FIG. 14 schematically illustrates a simplified block diagram of at least one layer model according to exemplary embodiments.

FIG. 15 schematically illustrates a simplified flow diagram of a method including determining based on a first THz signal TS-1, for example using at least one temporal windowing, a first partial signal TS-1-a according to exemplary embodiments.

FIG. 16 schematically illustrates a simplified flow diagram for determining a thickness D-10 of the substrate using a first layer model according to exemplary embodiments.

FIG. 17 schematically illustrates a simplified block diagram of partial signals TS-1-a, TS-1-b of a THz signal TS-1 according to exemplary embodiments.

FIG. 18 schematically illustrates a simplified timing diagram of a THz signal TS-1 according to exemplary embodiments.

FIG. 19A schematically illustrates a transfer function according to exemplary embodiments.

FIG. 19B schematically illustrates aspects of the transfer function according to FIG. 19A.

FIG. 20A schematically illustrates aspects of the transfer function according to FIG. 19A.

FIG. 20B schematically illustrates aspects of the transfer function according to FIG. 19A.

FIG. 21 schematically illustrates a simplified flow diagram for determining a layer thickness of at least one layer and the thickness D-10 of the substrate using a second layer model according to exemplary embodiments.

FIG. 22 schematically illustrates a simplified flow diagram for determining a thickness of the substrate and/or at least one layer at a plurality of measuring points according to exemplary embodiments.

FIG. 23 schematically illustrates a simplified flow diagram of determining a transmission T based on a complexity of a shape of the object according to exemplary embodiments.

FIG. 24 schematically illustrates a simplified flow diagram of modeling a transmitter S-ES emitting the electromagnetic radiation ES and/or modeling a receiver E-ES receiving the electro-magnetic radiation ES according to exemplary embodiments.

FIG. 25 schematically illustrates a simplified block diagram of the transmitter S-ES and the receiver E-ES according to exemplary embodiments.

FIG. 26 schematically illustrates a simplified flow diagram for providing for an overall model MOD-GES for the transmission T based on an object model MOD-1 for the object OBJ, and on at least one further model MOD-S-ES, MOD-E-ES that characterizes a transmitter S-ES and/or a receiver E-ES of the electromagnetic radiation ES according to exemplary embodiments.

FIG. 27 schematically illustrates a simplified block diagram of a device for performing one or more methods described herein according to exemplary embodiments.

FIG. 28 schematically illustrates aspects of uses according to exemplary embodiments.

FIG. 29 schematically illustrates a simplified block diagram of a THz device according to exemplary embodiments.

FIG. 30 schematically illustrates a simplified flow diagram according to exemplary embodiments.

FIG. 31 schematically illustrates a simplified beam diagram according to exemplary embodiments.

### DETAILED DESCRIPTION

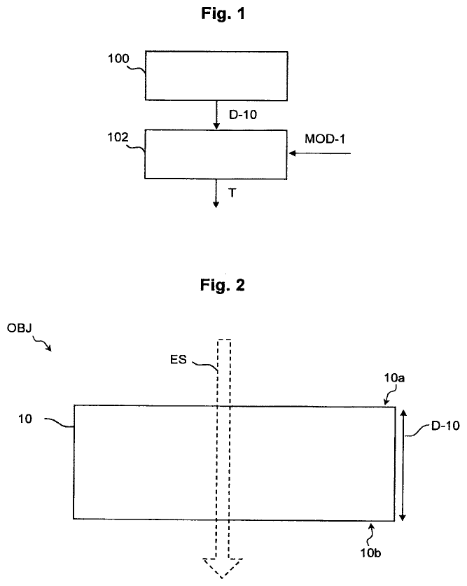

Exemplary embodiments, cf. FIGS. 1, 2, relate to a method, for example a computer-implemented method, for determining a transmission of an object OBJ, for example a substrate 10, for electromagnetic radiation ES in a frequency range between 30 gigahertz (GHz) and 200 GHz, comprising: determining 100 (FIG. 1) a thickness D-10 of the substrate 10 of at least one location of the object OBJ, determining 102 the transmission T using or by means of a first model MOD-1 characterizing the transmission T of the object OBJ for the electromagnetic radiation ES based on at least the thickness D-10 of the substrate 10. Thus, in some exemplary embodiments, an efficient determination of the transmission T of the object OBJ for the electromagnetic radiation ES is enabled.

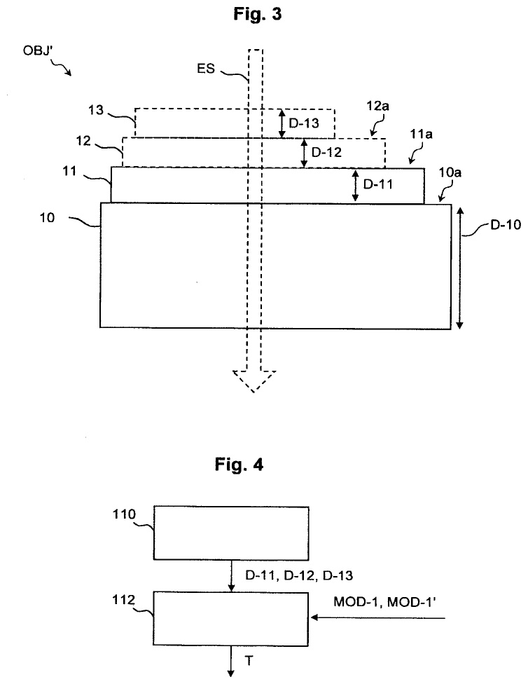

In further exemplary embodiments, FIGS. 3, 4, it is provided that the at least one layer 11, 12, 13 is arranged on the substrate 10, for example on a first surface 10a of the substrate 10, wherein the method comprises determining 110 a layer thickness D-11, D-12, D-13 of the at least one layer 11, 12, 13, for example some layers, for example all layers 11, 12, 13, of the at least one layer, for example at least one location of the object OBJ′, and determining 112 the transmission T by means of the first model MOD-1 and/or at least one further model MOD-1′, which characterizes the transmission T of the object OBJ′ for the electromagnetic radiation ES, based at least on the thickness D-10 of the substrate and on the layer thickness D-11, D-12, D-13 of the at least one layer 11, 12, 13.

In the object OBJ′ according to FIG. 3, a first layer 11 is arranged on the surface 10a of the substrate, and a second layer 12 is arranged on the surface 11a of the first layer 11, and a third layer 13 is arranged on the surface 12a of the second layer 12.

In further exemplary embodiments, the substrate 10 may, for example, comprise a plastic material, such as polypropylene. In further exemplary embodiments, the at least one layer 11, 12, 13 on the substrate 10 may be a paint layer and/or primer or the like.

In further exemplary embodiments, the object OBJ, OBJ′ is, for example, a component for a vehicle, for example a motor vehicle, for example a body part, for example a body part to be painted or coated.

In further exemplary embodiments, the thickness D-10 of the substrate 10 is at least ten times greater than the layer thickness D-11, D-12, D-13 of the at least one layer 11, 12, 13, for example at least fifty times greater, wherein, for example, a thickness D-10 of the substrate 10 is greater than or equal to 1 millimeter, mm.

In further exemplary embodiments, the thickness D-10 of the substrate 10 is at least three times, e.g. five times, greater than the layer thickness D-11, D-12, D-13 of the at least one layer 11, 12, 13. In further exemplary embodiments, the thickness D-10 of the substrate 10 may also be less than or equal to 1 mm, and the layer thickness of at least one layer 11 may be, for example, 200 μm (micrometers).

In further exemplary embodiments, it is provided that the electromagnetic radiation ES has frequencies between 20 GHz and 90 GHZ, for example between 60 GHz and 85 GHZ.

In further exemplary embodiments, it is provided that the electromagnetic radiation ES has frequencies in a radar frequency range, for example for radar applications in the automotive sector.

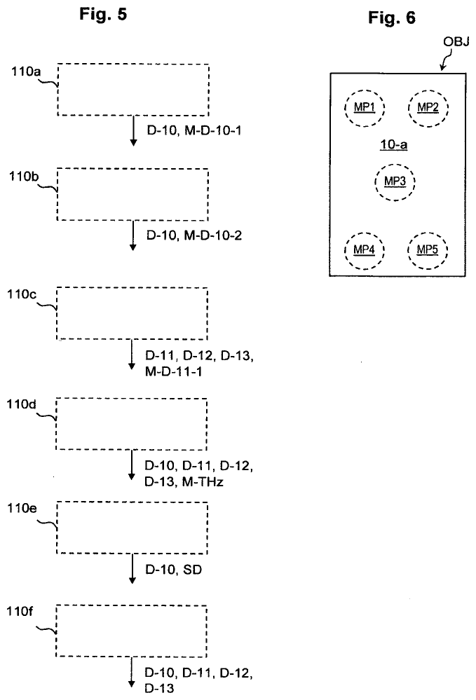

In further exemplary embodiments, FIG. 5, it is provided that the method comprises at least one of the following elements: a) determining 110a the thickness D-10 of the substrate 10, for example for one or more measuring points MP1, MP2, MP3, MP4, MP5, see FIG. 6, using at least one measurement M-D-10-1 based on terahertz radiation (“THz-based measurement”), b) determining 110b the thickness D-10 of the substrate 10, for example for one or more measuring points MP1, MP2, MP3, MP4, MP5, using at least one measurement M-D-10-2 which is not based on terahertz radiation, for example based on an optical and/or a mechanical measuring principle, c) determining 110c the layer thickness D-11, D-12, D-13 of the at least one layer 11, 12, 13, for example for one or more measuring points MP1, MP2, MP3, MP4, MP5, using at least one measurement M-D-11-1 based on terahertz radiation, d) determining 110d the thickness D-10 of the substrate 10 and the layer thickness D-11, D-12, D-13 of the at least one layer 11, 12, 13 using at least one measurement M-THz based on terahertz radiation, for example common to the substrate 10 and the at least one layer 11, 12, 13, e) determining 110e the thickness D-10 of the substrate 10, for example for one of more measuring points MP1, MP2, MP3, MP4, MP5 based on structured data SD, for example CAD data of the object OBJ, f) determining 110f the thickness D-10 of the substrate and/or the at least on layer thickness D-11, D-12, D-13, for example one or more measuring points MP3, based on existing thickness or layer thickness values, for example of at least one other measuring point MP1, MP2, MP4, MP5, for example using interpolation and/or extrapolation.

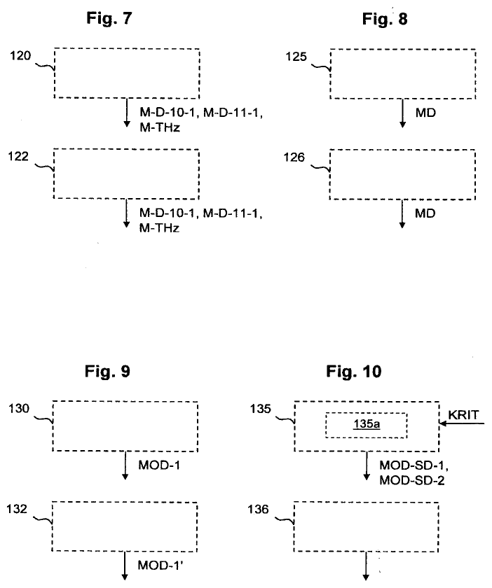

In further exemplary embodiments, FIG. 7, it is provided that the method comprises at least one of the following elements: a) performing 120 at least one measurement M-D-10-1, M-D-11-1, M-THz based on reflection of the terahertz radiation, b) performing 122 at least one measurement M-D-10-1, M-D-11-1, M-THz based on transmission of the terahertz radiation, wherein, for example, the terahertz radiation has a frequency range between 0.05 terahertz (THz) and 10 THz, for example between 0.1 THz and 6 THz.

While in some conventional approaches, a signal-to-noise ratio of THz-based measurements may not be sufficient to directly determine, for example, a (radar) transmission of the object with sufficient accuracy, exemplary embodiments allow, for example, using the MOD-1, MOD-1′ model to determine the transmission, e.g. radar transmission, T of the object based on at least one THz-based measurement.

In further exemplary embodiments, the transmission T of the object OBJ, OBJ′ for the electromagnetic radiation ES in the radar frequency range can, for example, be efficiently determined based on at least one THz-based reflection measurement. In further exemplary embodiments, the at least one THz-based reflection measurement can optionally additionally be used for a determination of the thickness of the substrate 10 and/or the at least one layer 11, 12, 13. In other words, in further exemplary embodiments, based on at least one THz-based reflection measurement, both thicknesses or layer thicknesses of the object OBJ, OBJ′ can be determined, as well as a transmission T of the object OBJ, OBJ′ in a frequency range that may be at least partially different from the frequency range of the THz radiation, e.g., a radar frequency range.

In further exemplary embodiments, in FIG. 8, it is provided that the method comprises: providing 125 material data MD characterizing a propagation of the electromagnetic radiation ES in the object OBJ, OBJ′, for example in the substrate 10 and/or in the at least one layer 11, 12, 13, wherein, for example, the material data MD comprises at least one of the following elements: a) dispersion relations, for example comprising a refractive index, for example frequency-dependent and/or frequency-independent, and/or an absorption index, for example frequency-dependent and/or frequency-independent, b) surface properties (e.g. roughness and/or curvature), and, optionally, using 126 the material data, for example for determining the transmission T. For example, in further exemplary embodiments, the material data MD can be taken into account in the model MOD-1, MOD-1′.

In further exemplary embodiments, for example, frequency-dependent dispersions can be used for at least one material, for example if they are known for the at least one material in question.

In further exemplary embodiments, for example, frequency-independent dispersions can also be used for at least one material.

In other exemplary embodiments, it may also be sufficient, for example, to use frequency-independent material data, which can simplify the evaluation.

In further exemplary embodiments, FIG. 9, it is provided that the method comprises at least one of the following elements: a) providing 130 the first model MOD-1, for example as an object model which characterizes, for example, the transmission T based on the thickness D-10 of the substrate 10 and/or based on material data MD associated with the object OBJ, OBJ′, for example the substrate 10, b) providing 132 the at least one further model MOD-1′, for example as an object model which characterizes, for example, the transmission T based on the thickness D-10 of the substrate 10 and the layer thickness D-11, D-12, D-13 of the at least one layer 11, 12, 13 and/or based on material data MD associated with the object OBJ, OBJ′, for example the substrate 10 and/or the at least one layer 11, 12, 13.

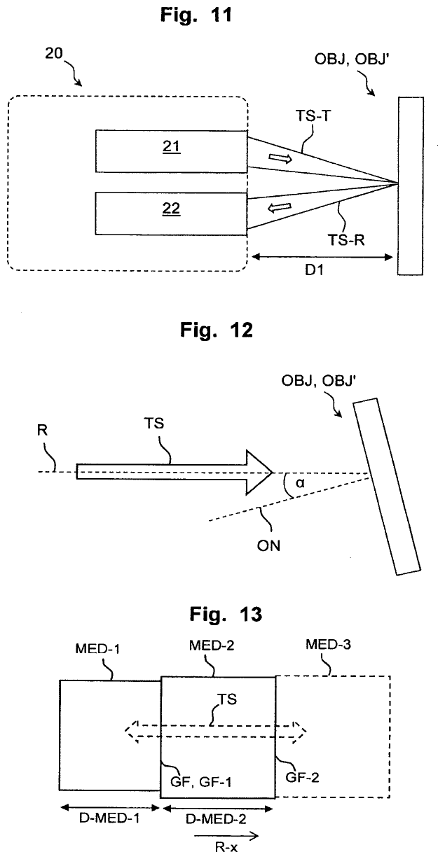

In further exemplary embodiments, FIGS. 10, 11, it is provided that the method comprises: taking into account 135 a dependence of a propagation of the terahertz radiation in the object OBJ, OBJ′ on at least one of the following criteria KRIT: a) distance D1 of a transmitter 21 and/or receiver 22 for the terahertz radiation TS-T, TS-R from the object OBJ, OBJ′, for example from a surface 10a (FIG. 2) of the substrate 10, b) thickness D-10 of the substrate 10 and/or layer thickness D-11, D-12, D-13 of the at least one layer 11, 12, 13, c) angle α (FIG. 12) between a main beam direction R of the terahertz radiation TS and a surface normal ON of at least one, for example, outer and/or inner interface 10a of the object OBJ, OBJ′ and/or of the substrate 10a, e.g. in the present example the surface 10a of the substrate 10.

In the exemplary configuration according to FIG. 11, a THz device 20, for example a measuring head, is provided, which has a transmitter 21 for emitting THz radiation TS-T, for example onto the object OBJ, OBJ′, and a receiver 22 for receiving THz radiation TS-R, for example reflected at the object OBJ, OBJ′. In further exemplary embodiments, a THz transceiver (transceiver, not shown) may also be provided.

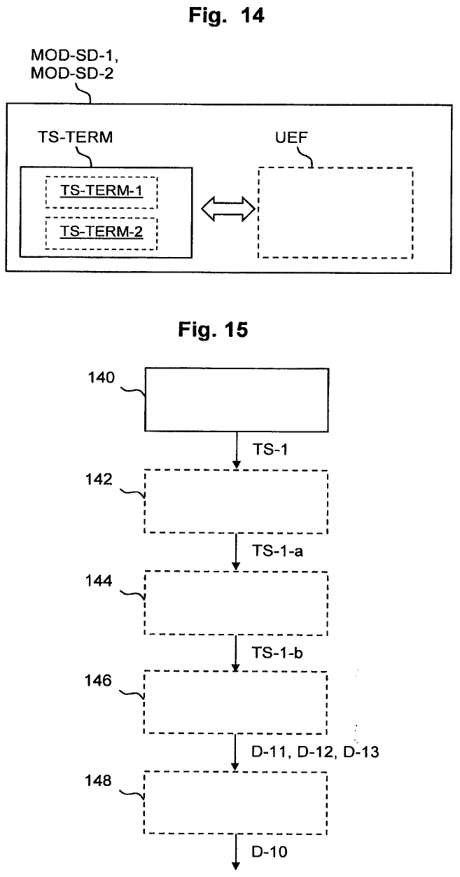

In further exemplary embodiments, FIGS. 10, 13, it is provided that the taking into account 135 comprises: characterizing 135a, using at least one layer model MOD-SD-1, MOD-SD-2, a propagation of the terahertz radiation TS (FIG. 13), TS-T, TS-R in the region of at least one interface GF, GF-1 between two adjacent media MED-1, MED-2 in a spatial region associated with the object OBJ, OBJ′, wherein the at least one layer model MOD-SD-1, MOD-SD-2, cf. FIG. 14, has a term TS-TERM characterizing the THz radiation TS, which is dependent on at least one of the following elements: a) frequency of the terahertz radiation TS, b) spatial extent D-MED-1, D-MED-2 (FIG. 13) and/or position of at least one of the two adjacent media MED-1, MED-2, for example along a first spatial direction R-x, wherein, for example, A) the at least one layer model MOD-SD-1 characterizes at least one reflection and/or transmission of the terahertz radiation at the at least one interface GF, GF-1 between the at least two media MED-1, MED-2, wherein, for example, the at least one layer model MOD-SD-1 characterizes several reflections and/or transmissions of the terahertz radiation TS for at least two interfaces GF, GF-1, GF-2 between different media MED-1, MED-2, MED-3, wherein, for example, the term TS-TERM characterizing the terahertz radiation TS has a respectively different value TS-TERM-1, TS-TERM-2 for the at least two interfaces GF-1, GF-2, wherein, for example, B) the at least one layer model MOD-SD-1 characterizes one or the plurality of reflections and/or transmissions of the terahertz radiation TS at a plurality of interfaces GF-1, GF-2 between in each case two media MED-1, MED-2, MED-3 adjoining one another in the spatial region by means of a coherent superposition function UEF (FIG. 14), the term TS-TERM being provided as a weighting factor, for example a weighting factor other than one, for at least some components of the coherent superposition function UEF.

In further exemplary embodiments, it is provided that the at least one layer model MOD-SD-1, MOD-SD-2 has a first component which characterizes a sample measurement on the object OBJ, OBJ′ in reflection arrangement or transmission arrangement by means of the terahertz radiation TS, wherein the first component can be characterized in a frequency space, for example for the reflection arrangement, based on the following equation:

$${F}_{S} ( ω , x , y , z ) = {I}_{0} ( ω , x , y , z ) exp [ - i \frac{ω}{{c}_{0}} [ 2 ( L + Δ D ) ( {n}_{A} - i {ϵ}_{A} ) ] + i {ϕ}_{0} ( ω , x , y , z ) ] . ( {t}_{A 1} {t}_{1 A} {\sum }_{R = 0}^{∞} {r}_{1 S}^{R + 1} {r}_{1 A}^{R} G ( D , R , ω , x , y , z , α , β , Ω ) exp [ - i \frac{ω}{{c}_{0}} ( 2 R + 2 ) D ( n - i ϵ ) ] + {r}_{A 1} )$$

where F_{S}(ω, x, y, z) characterizes, for example, a frequency-dependent field strength of a sample signal, wherein ω characterizes an circular frequency associated with a frequency of the terahertz radiation, wherein x characterizes a first spatial coordinate, wherein y characterizes a second spatial coordinate, wherein z characterizing a third spatial coordinate, wherein I₀ (ω, x, y, z) characterizes a field strength, for example frequency-dependent, of the terahertz radiation TS, TS-T at an emitter 21 generating the terahertz radiation, wherein exp [ ] characterizes an exponential function, where i characterizes the imaginary unit, where c₀ characterizes the vacuum light velocity, wherein L characterizing a distance between a terahertz device 20 (e.g. comprising an emitter 21 and/or receiver 22 for the THz radiation TS) and a reference object (not shown), wherein ΔD characterizes an offset between the reference object and the object OBJ, OBJ′, wherein n_{A} characterizing a refractive index of a medium present in the spatial region, for example air, wherein ϵ_{A} characterizing an extinction coefficient of the medium present in the spatial region, wherein ϕ₀ (ω, x, y, z) characterizing a phase, for example frequency-dependent, of the terahertz radiation TS, TS-T at the emitter 21 generating the terahertz radiation, wherein t_{A1} characterizing a transmission coefficient at an interface between the medium present in the spatial region and a layer characterizing a surface of the object OBJ, OBJ′, wherein t_{1A} characterizing a transmission coefficient at the interface between the layer characterizing the surface of the object and the medium present in the spatial region, wherein r_{1S} characterizes a reflection coefficient at an interface between a layer of the object and a substrate, wherein R characterizing a reflection index which characterizes a number and/or sequence of reflections and/or transmissions of the terahertz radiation, wherein r_{1A} characterizing a reflection coefficient at the interface between the layer characterizing the surface of the object and the medium present in the spatial region, wherein G(D, R, ω, x, y, z, α, β, Ω) characterizes the term TS-TERM characterizing the THz radiation or a or the weighting factor, wherein D characterizes a layer thickness of a layer, wherein n characterizes a refractive index of a layer, wherein ϵ characterizes an extinction coefficient of a layer, wherein r_{A1} characterizes a reflection coefficient at an interface between the medium present in the spatial region and a layer characterizing a surface of the object, wherein α and/or β optionally characterizing an angular orientation of the terahertz device 20 relative to the object OBJ, OBJ′, wherein ∩ optionally characterizing properties of a surface of the object OBJ, OBJ′, wherein the properties of the surface of the object comprise, for example, at least one of the following elements: a) shape of the surface, for example curvature, b) roughness of the surface.

In further exemplary embodiments, the term TS-TERM characterizing the THz radiation or G(D, R, ω, x, y, z, α, β, (∩) can also assume the value one, for example at least for some summands.

In further exemplary embodiments, it is provided that the at least one layer model MOD-SD-1, MOD-SD-2 has a second component which characterizes a reference measurement on a reference object in reflection arrangement or transmission arrangement by means of the terahertz radiation TS, wherein the second component can be characterized in the frequency space, for example for the reflection arrangement, based on the following equation:

$$F ( ω , x , y , z ) = {I}_{0} ( ω , x , y , z ) exp [ - i \frac{ω}{{c}_{0}} ( 2 L ) ( {n}_{A} - i {ϵ}_{A} ) + i {ϕ}_{0} ( ω , x , y , z ) ] \cdot {r}_{A M}$$

where F(ω, x, y, z) characterizes a, for example frequency-dependent, field strength of a reference signal, wherein r_{AM} characterizes a reflection coefficient at an interface between the medium present in the spatial region and a surface of the reference object.

In further exemplary embodiments, it is provided that the at least one layer model, for example for a reflection arrangement, can be characterized in a or the frequency space, for example based on the following equation:

$$H ( ω ) = exp [ - i \frac{ω}{{c}_{0}} ( 2 Δ D ) ( {n}_{A} - i {ϵ}_{A} ) ] \cdot ( {t}_{A 1} {t}_{1 A} {\sum }_{R = 0}^{∞} {r}_{1 S}^{R + 1} {r}_{1 A}^{R} G ( D , R , ω , x , y , z , α , β , Ω ) exp [ - i \frac{ω}{{c}_{0}} ( 2 R + 2 ) D ( n - i ϵ ) ] + {r}_{A 1} ) / {r}_{AM}$$

wherein H(ω) characterizes a transfer function, for example related to a reference measurement, of the terahertz radiation.

In further exemplary embodiments, it is provided that the term TS-TERM, as an alternative or in addition to a) the frequency of the terahertz radiation TS, and/or b) the spatial extent D-MED-1, D-MED-2 (FIG. 13) and/or position of at least one of the two adjacent media MED-1, MED-2, for example along a first spatial direction R-x, is dependent on at least one of the following elements: c) reflection index characterizing a number and sequence of reflections and/or transmissions, d) angular orientation a of the terahertz device 20 with respect to the object OBJ, OBJ′ and/or the reference object (not shown), e) distance, for example between the at least one terahertz device and/or the at least one object, f) property of a surface of the at least one object, for example a shape of the surface and/or a roughness of the surface.

In further exemplary embodiments, it is provided that the at least one layer model MOD-SD-1, MOD-SD-2, for example by means of the term TS-TERM or the weighting factor, models a distance-dependent spectral change of a transfer function of the terahertz radiation TS as a distance-dependent or depth-dependent attenuation and/or amplification.

In further exemplary embodiments, it is provided that the at least one layer model MOD-SD-1, MOD-SD-2, for example by means of the term TS-TERM or the weighting factor, models an angle-dependent spectral change of a transfer function of the terahertz radiation TS as angle-dependent attenuation and/or amplification.

In further exemplary embodiments, it is provided that the at least one layer model MOD-SD-1, MOD-SD-2 models, for example by means of the term TS-TERM or the weighting factor, a spectral change of a transfer function of the terahertz radiation TS based on at least one property of a or the surface of the at least one object OBJ, OBJ′, for example based on a shape of the surface and/or a roughness of the surface.

In further exemplary embodiments, it is provided that the at least one layer model MOD-SD-2 comprises or characterizes an object OBJ′ comprising several layers of different media, wherein, for example, the at least one layer model MOD-SD-2 characterizes at least one of the following elements: a) reflections and/or transmissions of the terahertz radiation TS in the object OBJ′, for example between adjacent layers, b) multiple reflections and/or multiple transmissions of the terahertz radiation TS in the object OBJ′, c) virtual reflection points and/or virtual transmission points, for example characterizable by a reflection index, in the object OBJ′, d) coherent superposition of the various reflections and/or transmissions of the terahertz radiation TS in the object OBJ′.

In further exemplary embodiments, it is provided that the method further comprises: determining the term TS-TERM (FIG. 14) and/or individual values TS-TERM-1, TS-TERM-2 of the term TS-TERM based on an optical model of a system characterizing the terahertz device 20 and the object OBJ, OBJ′ or the reference object (not shown), and, optionally, an ambient medium (not shown) surrounding the terahertz device and the object or the reference object, wherein, for example, the optical model characterizes a spectral transfer function of the terahertz radiation TS, for example within the system.

In further exemplary embodiments, it is provided that the method further comprises: determining the term TS-TERM and/or individual values TS-TERM-1, TS-TERM-2 of the term based on an optical model of a system characterizing the terahertz device 20 and the object OBJ, OBJ′ or the reference object, and, optionally, an ambient medium surrounding the terahertz device and the object or the reference object, wherein the optical model characterizes an amplitude and phase over the spatial extent of the terahertz radiation TS, for example within the system.

In further exemplary embodiments, it is provided that the optical model takes into account diffraction effects of the terahertz radiation TS.

In further exemplary embodiments, it is provided that the method further comprises: determining the optical model based on modeling by means of a) ray tracing and/or b) a diffraction-theoretical description, e.g. by means of a diffraction integral, e.g. Collins integral, and/or c) a parametric calculation with model function, and, optionally, calibrating the optical model, wherein, for example, the determining and/or calibrating of the optical model is performed with frequency resolution.

In further exemplary embodiments, it is provided that the method further comprises: calibrating the optical model, for example with respect to the spectral transfer function and/or the spatial amplitude and/or phase, based on at least one of the following elements: a) angle α0 between an optical axis R (FIG. 11) of the terahertz device 20 and a surface normal ON of the object OBJ, OBJ′ or of the reference object, b) distance DI between the terahertz device 20 and a surface of the object OBJ, OBJ′ or of the reference object, c) property of a or the surface of the at least one object or of a reference object, for example based on a shape, for example curvature, of the surface and/or a roughness of the surface, d) frequency of the terahertz radiation TS.

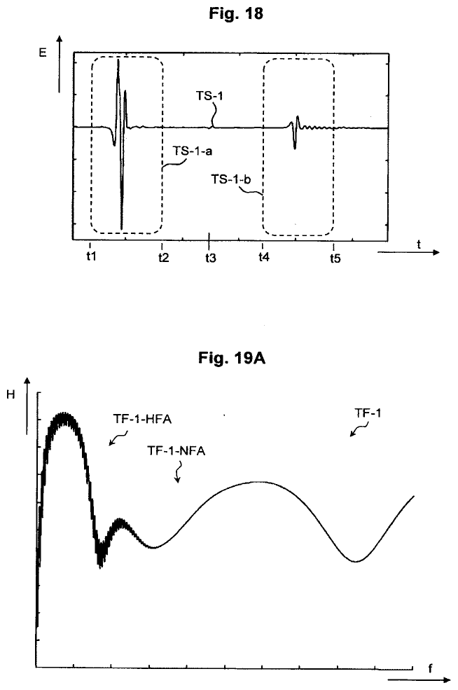

In further exemplary embodiments, FIGS. 14, 18, it is provided that the method comprises: determining 140 a first, for example time-resolved, THz signal TS-1, wherein the method further comprises: determining 142 (FIG. 15), based on the first THz signal TS-1, for example using at least one temporal windowing, a first partial signal TS-1-a, wherein, for example, the first partial signal TS-1-a characterizes THz radiation which a) is reflected at a first interface GS-1, see FIG. 17, between the at least one layer 11 and the substrate 10, for example the first surface 10a of the substrate 10, (and/or at least one further interface, for example between two adjacent layers 11, 12), FIG. 17, between the at least one layer 11 and the substrate 10, for example the first surface 10a of the substrate 10, (and/or at least one further interface, for example between two adjacent layers 11, 12), for example b) but has not been reflected at a second surface 10b of the substrate 10 opposite the first surface 10a of the substrate 10.

In further exemplary embodiments, FIGS. 15, 17, 18, it is provided that the method comprises: determining 144 a second partial signal TS-1-b, wherein, for example, the second partial signal TS-1-b characterizes THz radiation which has been reflected, for example, inter alia, at a second interface 10b opposite the first interface 10a (FIG. 17), wherein, for example, a second surface 10b of the substrate 10 opposite the first surface 10a of the substrate 10 forms the second interface.

In further exemplary embodiments, a meaningful separation into the partial signals TS-1-a, TS-1b can be achieved, for example, if the first partial signal TS-1-a comprises a reflection between a last layer (e.g. directly on the surface 10a of the substrate 10) and a substrate front side or substrate surface 10a.

In further exemplary embodiments, FIG. 15, it is provided that the method comprises: determining 146 the layer thickness D-11, D-12, D-13 of the at least one layer 11, 12, 13 based on the first partial signal TS-1-a, for example using a or the first layer model MOD-SD-1 for the at least one layer.

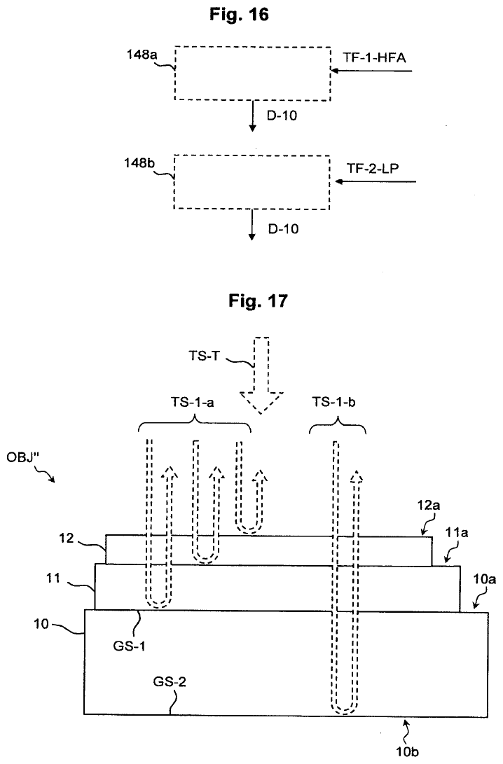

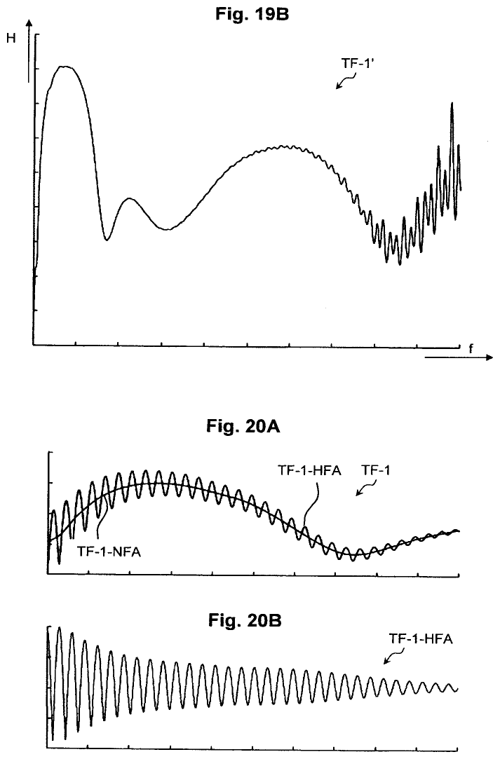

In further exemplary embodiments, FIGS. 15, 16, it is provided that the method comprises: determining 148 the thickness D-10 of the substrate 10 based on the first THz signal TS-1, wherein, for example, the determining 148 the thickness D-10 of the substrate 10 based on the first THz signal TS-1 comprises at least one of the following elements: a) determining 148a the thickness D-10 of the substrate 10 based on a high-frequency portion TF-1-HFA of a transfer function TF-1 associated with the first THz signal TS-1, see e.g. FIG. e.g. FIG. 19A, b) determining 148b (FIG. 16) the thickness D-10 of the substrate 10 based on a phase TF-2-LP, for example linear, which characterizes a difference of a phase of a transfer function TF-2 associated with the second partial signal TS-1b and a phase of a transfer function TF-1 associated with the first partial signal TS-1-a.

FIG. 18 shows an example of a THz signal TS-1 obtained according to exemplary embodiments, for example in a reflection arrangement, for example according to FIG. 13, characterized by a time characteristic of an electric field strength E over time t. The first partial signal TS-1-a is contained in the signal TS-1 for example between the times t1, t2, and the second partial signal TS-1-b is contained in the signal TS-1 for example between the times t4, t5, wherein in further exemplary embodiments the partial signals can be separated from one another for example via a temporal windowing or in some other way, for example in the range of the time t3, with t2 <=t3<=t4.

According to investigations by the applicant, in exemplary embodiments, the first partial signal TS-1-a has information about the layers 11, 12, 13 or their thicknesses D-11, D-12, D-13 (e.g, because it generally originates from a reflection of THz radiation TS, TS-T irradiated onto the object at the interfaces 10a, 11a, 12a between the layers 11, 12, 13 (or also between the layer 13 and a surrounding medium, e.g. air)), while the first partial signal TS-1-a and the second partial signal TS-1-b, which e.g. due to a comparatively long propagation time through the substrate 10, e.g. from the first surface 10a to the second surface 10b and from there back to the first surface 10a and finally back to the THz receiver 22, has a time delay with respect to the first partial signal TS-1-a which is clearly perceptible in FIG. 18, has information about the thickness D-10 of the substrate.

In further exemplary embodiments, the thickness D-10 of the substrate 10 and/or the layer thicknesses D-11, D-12, D-13 can thus be determined based on the first THz signal TS-1.

FIG. 19A schematically shows a transfer function TF-1 of the THz radiation, as can be determined in further exemplary embodiments, e.g. based on the THz signal TS-1. The diagram of FIG. 19A shows an exemplary frequency range from about 0 THz to about 5 THz.

It can be seen that at comparatively low THz frequencies “high-frequency components” TF-1-HFA of the transfer function TF-1 are present, which are superimposed on comparatively low-frequency components TF-1-NFA and, according to the applicant's investigations, correlate with the thickness D-10 of the substrate 10.

FIG. 19B schematically shows a transfer function TF-1′ modified according to further exemplary embodiments, which has been adjusted for the “high-frequency components” TF-1-HFA (FIG. 19A).

FIG. 20A schematically shows a detail of the transfer function TF-1 according to FIG. 19A, in which the “high-frequency components” TF-1-HFA and the “low-frequency components” TF-1-NFA are each labeled separately, and FIG. 20B shows only the “high-frequency components” TF-1-HFA.

In further exemplary embodiments, the transfer function TF-1 comprises, for example, the aforementioned low-frequency and high-frequency components TF-1-NFA, TF-1-HFA. In further exemplary embodiments, the low-frequency components TF-1-NFA can be assigned, for example, to the comparatively thin layers 11, 12, 13, e.g. paint layers, and the high-frequency components TF-1-HFA can be assigned, among other things, to the comparatively large substrate layer thickness D-10.

In further exemplary embodiments, the low-frequency components TF-1-NFA can be extracted, for example, by considering only reflections at the “upper layers” 11, 12, 13, which can be characterized, for example, by the first partial signal TS-1-a.

In further exemplary embodiments, the high-frequency component TF-1-HFA, which in further exemplary embodiments is generally superimposed with the transfer function TF-1′ (FIG. 19B), can be extracted from the transfer function TF-1 (FIG. 19A), e.g. using the following procedure:
a) Determination of the transfer function of the low-frequency component TF-1-NFA, e.g. by (temporal) separation of the first partial signal TS-1-a.
b) Subtraction of this transfer function TF-1-NFA (FIG. 19B) of the low-frequency component from the total transfer function TF-1. In further exemplary embodiments, the result includes, for example, only the high-frequency component TF-1-HFA, see FIG. 20B.

In further exemplary embodiments, a frequency of the oscillation of the high-frequency component TF-1-HFA is determined e.g. by means of a Fourier transform, e.g. FFT or DFT, and contains e.g. information about a time delay (Δτ) between the two sub-signals TS-1-a, TS-1-b, for example at least approximately proportional to t4-t1 according to FIG. 18 or to a respective zero crossing of the two sub-signals TS-1-a, TS-1-b or to a respective center of gravity of the two sub-signals TS-1-a, TS-1-b.

In further exemplary embodiments, the information about the time delay between the two partial signals TS-1-a, TS-1-b is determined At between the two partial signals TS-1-a, TS-1-b is determined in the time domain, for example by means of a search for neighboring extremes, e.g. maxima and/or first zero crossing and/or center of gravity.

In other exemplary embodiments, the information about the time delay between the two partial signals Δτ between the two partial signals TS-1-a, TS-1-b is determined by means of a fit of the high-frequency oscillation in the frequency domain.

In further exemplary embodiments, the information about the time delay between the two partial signals Δτ between the two partial signals TS-1-a, TS-1-b is determined by evaluating a phase information. According to investigations by the applicant, the time delay between the two partial signals Δτ between the two partial signals TS-1-a, TS-1-b is reflected in a change in the linear phase. In order to utilize this information, the two partial signals TS-1-a, TS-1-b are separated in further exemplary embodiments, see FIG. 18, and the transfer functions of the partial signals TS-1-a, TS-1-b are formed. The transfer function of the “time-delayed” second partial signal TS-1-b has —e.g. in comparison to a transfer function of the first partial signal TS-1-a —an, e.g. additional, linear phase (not shown). In further exemplary embodiments, the substrate layer thickness D-10 is determined from this linear phase, for example based on the equation

$$Δ τ = 2 d \frac{n}{c} ,$$

where Δτ den characterizes the temporal offset between the partial signals TS-1-a, TS-1-b, wherein d characterizes the substrate layer thickness D-10, wherein n characterizes a refractive index of the substrate 10, and wherein c characterizes the propagation speed (speed of light) in the substrate 10. For this purpose, in further exemplary embodiments, influences of the angle of incidence a (FIG. 12) and/or the layers 11, 12, 13, e.g. paint layers, can also be corrected, e.g. based on approaches for determining the high-frequency component TF-1-HFA.

In other words, in further exemplary embodiments, the delay

$$( Δ τ = 2 d \frac{n}{c} )$$

can be regarded as the time required for the THz radiation to propagate through a path (for example, the path for forward and backward transmission) in the substrate 10.

In further exemplary embodiments, the determination of Δτ can be carried out as follows. Without limiting the generality, it is assumed for the following example that the layers 11, 12, 13 are exemplarily formed as paint layers which are applied to the substrate 10. Determination of the temporal offset through the, e.g., comparatively thin layers 11, 12, 13, e.g., paint layers, is performed according to exemplary embodiments:

$$Δ {L}_{i} = 2 {D}_{i} ( \frac{{n}_{i}}{cos ( {θ}_{i} )} - {n}_{air} sin ( θ ) tan ( {θ}_{i} ) )$$

$$Δ L = {\sum }_{i}^{N} Δ {L}_{i}$$

Substrate thickness is determined according to exemplary embodiments:

$${D}_{Substrate} = \frac{1}{2 a} ( {c}_{0} Δ τ - Δ L )$$

$$α = \frac{{n}_{Substrate}}{cos ( {θ}_{s} )} - tan ( {θ}_{s} ) sin ( θ )$$

In further exemplary embodiments, the mean refractive indices are determined via the weighted mean value, e.g. since only one substrate layer thickness D-10 is determined. For this purpose, in further exemplary embodiments, for example, a THz reference spectrum can be used, which can be determined in a manner known per se.

Elements of the above equations are explained below as examples:
ΔLᵢ—Delay due to the paint layer i
ΔL—Delay through all paint layers
Dᵢ, nᵢ—Thickness and mean or frequency-resolved refractive index of the coating layer i
nₐᵢᵣ—Refractive index air
n_{Substrate}—Refractive index substrate
θ—Angle of incidence (e.g. similar to angle α from FIG. 12) in air
θᵢ—Angle of incidence in the paint layer i.
θₛ—Angle of incidence in the substrate
N—Number of thin layers of lacquer
Δτ—Time delay between the pulses

The information of the layer thicknesses, e.g. paint layer thicknesses, can be extracted in further exemplary embodiments, e.g. from a THz measurement, e.g. the first THz signal TS-1 (FIG. 18), e.g. by discarding the “rear pulse”, i.e. the second partial signal TS-1-b. The remaining “front pulse”, i.e. the first partial signal TS-1-a, then contains, for example, only the information of the paint layers 11, 12, 13. In a model-based fit according to further exemplary embodiments, the thicknesses D-11, D-12, D-13 of the paint layers 11, 12, 13 can be determined. Here, for example, an infinitely extended substrate 10 (e.g. thickness D-10 approaches infinity) is assumed in the model used.

In further exemplary embodiments, a total layer thickness (sum of the thicknesses D-11, D-12, D-13 of the (paint) layers and the thickness D-10 of the substrate 10) is determined by a distance measurement (e.g. by means of a (mechanical) caliper, a triangulation, . . . ). In further exemplary embodiments, the determination of the total layer thickness can, for example, be carried out alternatively or in addition to at least one THz-based measurement M-D-10-1, M-D-11-1, M-THz (FIG. 5).

The procedure for triangulation according to further exemplary embodiments is described as an example below:
1. Determination of a zero point by means of a reference measurement (e.g. on a reference object such as an uncoated substrate).
2. Sample is brought to the position of the reference measurement.
3. Determine the total thickness by measuring the top of the sample.
4. Subtract the thickness of the paint layers from the total thickness determined in step 3) above.

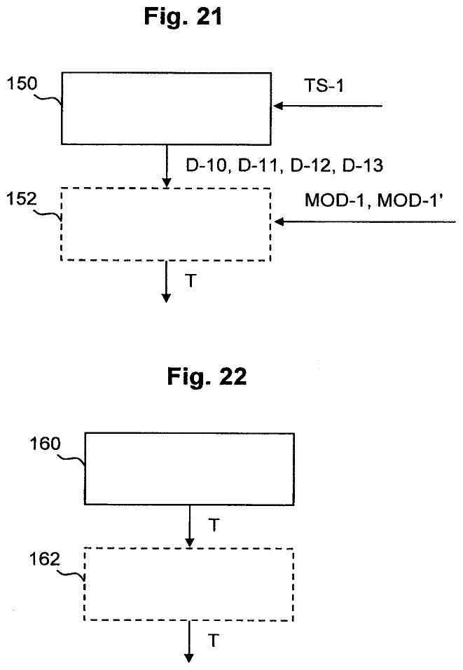

In further exemplary embodiments, FIG. 21, it is provided that the method comprises: determining 150 the layer thickness D-11, D-12, D-13 of the at least one layer 11, 12, 13 and the thickness D-10 of the substrate 10 based on the first THz signal TS-1, for example using a second layer model MOD-SD-2 for the substrate 10 with the at least one layer 11, 12, 13, for example using a fit method. In further exemplary embodiments, for example, previously determined layer thicknesses and/or substrate layer thickness(es) can be used, for example, as starting values for the fit method.

In further exemplary embodiments, FIGS. 21, 22, it is provided that the method comprises: determining 152, 160 the transmission T for at least one measuring point MP1, MP2, . . . of the object OBJ, OBJ′, OBJ″, and/or determining 162 the transmission for several measuring points MP1, MP2, . . . of the object OBJ, OBJ′, OBJ″. For this purpose, in further exemplary embodiments, for example, a respective measuring point of the object OBJ, OBJ′, OBJ″ can be brought into a measuring range of the THz device 20, for example by arranging the elements 20, OBJ, OBJ′, OBJ″ relative to each other, for example by means of at least one positioning system, e.g. robot, and then the first THz signal TS-1 can be determined for the respective measuring point MP1, for example, by means of a THz-based measurement based on reflection, cf. the exemplary arrangement of FIG. 11. The respective thickness D-10, D-11, D-12, D-13 can then be determined from the first THz signal TS-1, e.g. in the exemplary manner described above, whereby based on the respective thickness D-10, D-11, D-12, D-13, e.g. the transmission T of the object can be determined, e.g. the transmission T of the object OBJ, OBJ′, OBJ″ for the electromagnetic radiation ES (e.g. in the radar frequency range) can be determined at the current measuring point MP1, for example by means of the model MOD-1, MOD-1′.

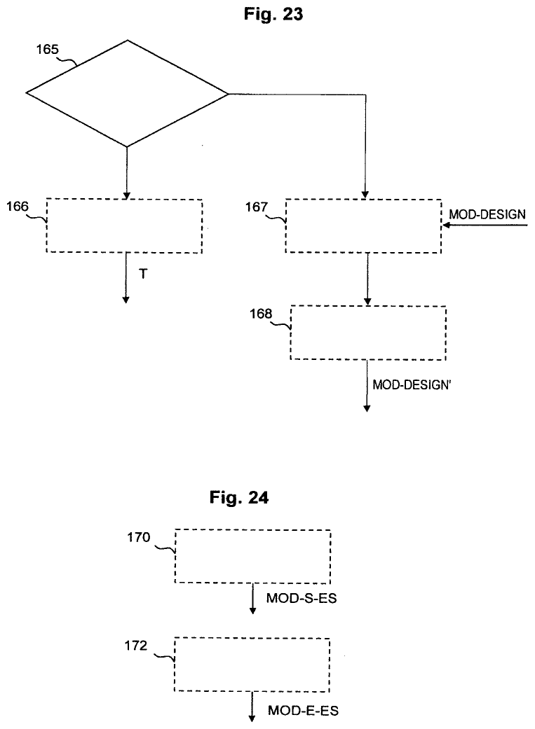

In further exemplary embodiments, FIG. 23, it is provided that the method comprises: determining 165 whether a complexity of the object OBJ, OBJ′, OBJ″, for example a complexity of a shape of the object, exceeds a predeterminable limit value, and, optionally, for example if the complexity does not exceed the predeterminable limit value, determining 166 the transmission T based on a plurality of measurement points MP1, MP2, . . . , for example based on averaging with respect to the multiple measurement points.

In further exemplary embodiments, the complexity of the object can be evaluated, for example, based on at least one of the following criteria: a) curvature of at least one surface 10a, b) presence of a constant thickness D-10, c) size of respective, e.g. continuous and differentiable, contiguous areas of a surface.

In further exemplary embodiments, it is provided that the method comprises: using 167, for example if the complexity exceeds the predeterminable limit value, a design model MOD-DESIGN, for example CAD model, of the object, wherein the design model MOD-DESIGN characterizes, for example, at least one surface structure and/or coating of the object, and, optionally, adapting 168 the design model MOD-DESIGN to a measured substrate thickness D-10 and/or layer thickness D-11, D-12, D-13, for example for one or more measuring points MP1, MP2, . . . (FIG. 6).

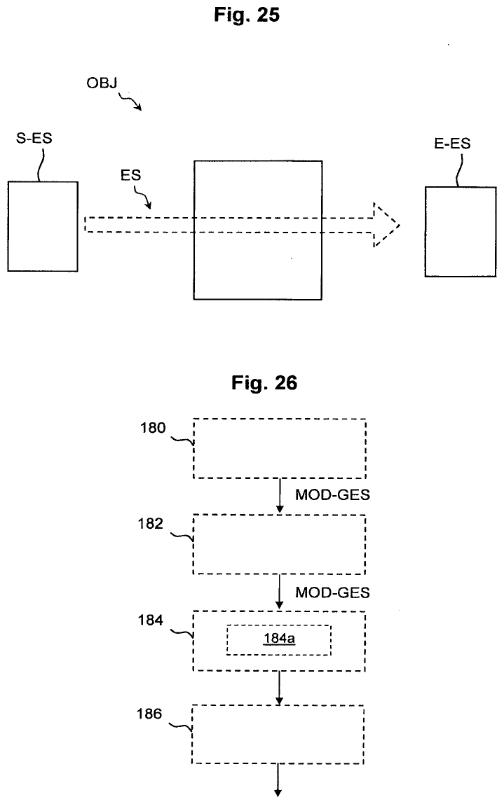

In further exemplary embodiments, FIGS. 24, 25, it is provided that the method comprises: modeling 170 of a transmitter S-ES emitting the electromagnetic radiation ES, e.g. radar transmitter, for example with respect to at least one of the following elements: a) position (e.g. relative to the object OBJ), b) size, c) beam angle or characteristic, d) beam intensity.

In further exemplary embodiments, it is provided that the method comprises: modeling 172 a receiver E-ES receiving the electromagnetic radiation ES, for example with respect to at least one of the following elements: a) position, b) size, c) characteristic.

In further exemplary embodiments, FIG. 26, it is provided that the method comprises: providing 180 an overall model MOD-GES for the transmission T (FIG. 1) based on an object model MOD-1 for the object OBJ, and on at least one further model MOD-S-ES, MOD-E-ES (FIG. 24), wherein the at least one further model MOD-S-ES, MOD-E-ES characterizes a transmitter S-ES and/or a receiver E-ES of the electromagnetic radiation ES, configuring 182 the overall model MOD-GES based on the transmission determined for at least one measuring point MP1, for example several measuring points MP1, MP2, . . . of the object, and/or based on determined layer thicknesses and/or substrate thicknesses and/or based on at least one, for example frequency-dependent and/or constant, refractive index and/or on at least one, for example frequency-dependent and/or constant, absorption index, and/or (other) material properties, evaluating 184 the overall model MOD-GES, and, optionally, adapting 186 at least one component of the overall model MOD-GES.

In further exemplary embodiments, FIG. 26, it is provided that the method comprises: determining 184a a received intensity of the electromagnetic radiation ES, wherein, for example, the evaluating 184 and/or the determining 184a is performed based on a ray tracing method and/or a, for example, other calculation method for the propagation of the electromagnetic radiation ES.

In further exemplary embodiments, the principle according to the embodiments enables an efficient assessment of a transmission T of an object OBJ for the electromagnetic radiation ES, e.g. based on at least one THz signal TS-1, wherein in further exemplary embodiments a comparatively high precision, in particular compared to a direct THz-based determination of the transmission, is achievable.

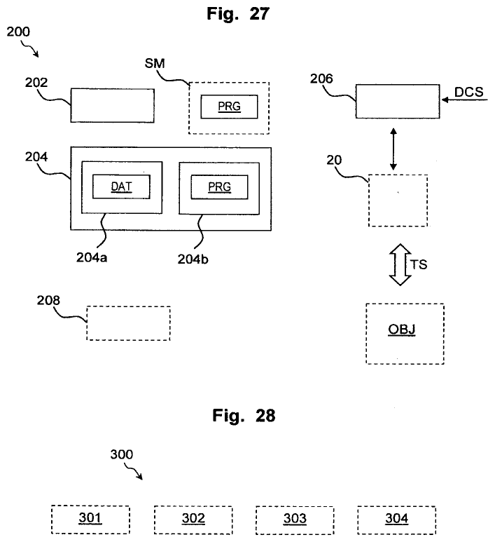

Further exemplary embodiments, FIG. 27, relate to a device 200 for carrying out the method according to the embodiments.

In further exemplary embodiments, it is provided that the device 200 comprises: a computing device (“computer”) 202, a memory device 204 associated with the computing device 202 for at least temporarily storing at least one of the following elements: a) data DAT (e.g. data of the model MOD-1 (FIG. 1)), b) computer program PRG, for example for executing a method according to the embodiments.

In further preferred embodiments, the memory device 204 comprises a volatile memory 204a (e.g. random access memory (RAM)), and/or a non-volatile memory 204b (e.g. flash EEPROM).

In further exemplary embodiments, the computing device 202 comprises at least one of the following elements or is configured as at least one of these elements: Microprocessor (μP), microcontroller (μC), application specific integrated circuit (ASIC), system on chip (SoC), programmable logic device (e.g. FPGA, field programmable gate array), hardware circuit, or any combination thereof.

Further exemplary embodiments relate to a computer readable storage medium SM comprising instructions PRG′ which, when executed by a computer 202, cause the computer 202 to perform the method according to the embodiments.

Further exemplary embodiments relate to a computer program PRG comprising instructions which, when the program is executed by a computer 202, cause the computer 202 to perform the method according to the embodiments.

Further exemplary embodiments relate to a data carrier signal DCS characterizing and/or transmitting the computer program PRG according to the embodiments. The data carrier signal DCS can be received, for example, via an optional data interface port 206 of the device 200.

In further exemplary embodiments, it is provided that the device 200 has at least one of the following elements: a) an interface port 206 to at least one THz measurement system 20 (see also FIG. 11), which is designed to transmit and/or receive terahertz radiation TS, TS-T, TS-R, wherein, for example, the THz measurement system 20 has at least one transmitter 21 for the terahertz radiation and/or a receiver 22 for the terahertz radiation and/or a transceiver for the terahertz radiation, b) a positioning system 208, for example a robot, e.g. industrial robot.

Further exemplary embodiments, FIG. 28, relate to a use 300 of the method according to the embodiments and/or the device according to the embodiments and/or the computer-readable storage medium according to the embodiments and/or the computer program according to the embodiments and/or the data carrier signal according to the embodiments for at least one of the following elements: a) determining 301 a transmission T of an object OBJ, OBJ′ in a radar frequency range based on a thickness measurement of at least one component 10, 11, 12, 13 of the object OBJ, OBJ′, b) determining 302 a transmission T of an object in a radar frequency range based on a thickness measurement of at least one component of the object based on the use of THz radiation TS, c) determining 303 a transmission T of an object in a radar frequency range based on reflection measurements using THz radiation, d) adapting 304 a design model MOD-DESIGN, for example CAD model, of the object, wherein, for example, an adapted design model MOD-DESIGN′ (FIG. 23) can be obtained, c) determining 305 a transmission T of an object OBJ, OBJ′, OBJ″ in a radar frequency range and of a thickness D-10 of the substrate 10 and/or at least one layer thickness D-11, D-12, D-13 of the at least one layer 11, 12, 13 based on at least one THz-based measurement, for example based on at least one, for example identical or joint, THz-based measurement M-THz (FIG. 5).

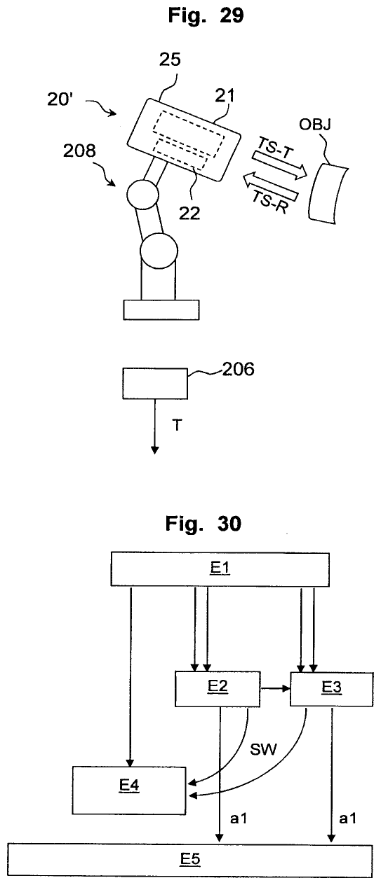

FIG. 29 schematically shows a THz device 20′ with a measuring head 25, which has a THz transmitter 21 for emitting THz radiation TS-T onto an object OBJ and a THz receiver 22 for receiving THz radiation TS-R reflected at the object OBJ. A positioning system 208 is associated with the THz device 20′ in order to move the THz device 20′ relative to the object OBJ (e.g. by means of translation and/or rotation), for example to detect predeterminable measurement points on the object OBJ. A computing device associated with the THz device 20′ (see, for example, the computer 202 according to FIG. 27) can execute the method according to exemplary embodiments, so that, for example, the transmission T of the object OBJ for electromagnetic radiation ES, e.g. in the radar frequency range, can be determined, e.g. at least one measuring point, and can be output, e.g. via the interface port 206.

In further exemplary embodiments, the THz device 20′ may be used, e.g., in a, e.g., industrial, manufacturing facility, e.g., to perform in-line coating thickness measurements of, e.g., wet and/or drying and/or dry coatings, e.g., paint coatings, to be applied or applied to the object OBJ and, e.g., based on the same THz measurement(s) M-THz as performed for the coating thickness measurements, wet and/or drying and/or dry layers, e.g. paint layers, to be applied to the object OBJ and, e.g. based on the same THz measurement(s) M-THz as performed for the layer thickness measurements, to determine the transmission, e.g. radar transmission, T of the object.

FIG. 30 shows an example of a simplified block diagram according to further exemplary embodiments. Block E1 symbolizes at least one THz-based measurement M-THz, in which, for example, the first THz signal TS-1 is obtained. Block E2 symbolizes a determination of the layer thicknesses D-11, D-12, D-13, for example paint layer thicknesses, based on the THz-based measurement E1. Block E3 symbolizes a determination of the thickness D-10 of the substrate 10 based on the THz-based measurement E1.

Block E4 symbolizes, for example, a joint determination of the layer thicknesses D-11, D-12, D-13, for example paint layer thicknesses, and the thickness D-10 of the substrate 10, for example based on at least one layer model MOD-SD-2. In further exemplary embodiments, the determination according to block E4 can be carried out alternatively or in addition to at least one of the blocks E2, E3.

Block E5 symbolizes a determination of the transmission T, e.g., radar transmission, based on the result of block E2 and/or E3 and/or E4.

A generally non-linear influence of the substrate and layer thicknesses D-10, D-11, . . . that can be determined by measurement can lead to poor adaptation in further exemplary embodiments, since optimization algorithms of the model-based approaches can converge to local minima, for example. This can be improved in further exemplary embodiments by a good choice of starting values SW. In further exemplary embodiments, the starting values are determined as follows, for example.

In further exemplary embodiments, the determination E4 of the paint layer thicknesses can be carried out, for example, by means of a model-based evaluation of the “front side reflection” TS-1-a (see, for example, FIG. 18 and element 146 of FIG. 15).

In further exemplary embodiments, the determination E3 of the substrate layer thickness D-10 can be carried out, for example, using at least one of the following approaches already described above: a) extraction of high-frequency components TF-1-HFA (element 148a according to FIG. 16); b) phase-based method 148b (FIG. 16); or c) determination by a further, e.g. non-THz-based measurement M-D-10-2 (e.g. caliper, triangulation).

The following variations are conceivable in other exemplary embodiments: (e.g. all) values or starting values (e.g. for a model-based fit E4) of the layer and substrate thicknesses can be used directly for the determination E5 of the radar transmission T. In this case, the fit E4 of an overall layer model to the measurement data described above as an example is skipped, see arrows a1.

In further exemplary embodiments, it is also conceivable to fix any number of the layer and substrate thicknesses determined in E2 and E3 as starting values in the fit process E4 (or for it or before it) and thus limit the number of degrees of freedom in the fit process E4.

In further exemplary embodiments, the principle according to the embodiments can be used to determine the transmission T, e.g. at one or more small (e.g. outer dimension, e.g. diameter, <1 mm) measuring points MP1.

In further exemplary embodiments, the principle according to the embodiments can (also) be used to determine the transmission T, e.g. radar transmission, through an e.g. extended and/or structured component OBJ. In further exemplary embodiments the radar transmission can be determined, for example for such components, for example by the following way: a) THz-based determination of the layer and substrate thickness D-10, D-11, D-12, . . . on several support points MP1, MP2, MP3 . . . ; b) optionally determination of the layer and substrate thickness on further points on the substrate, e.g. based on the THz-based determined thickness values, for example by means of interpolation and/or extrapolation, for example using CAD data of the object; c) determination of the radar transmission through an extended component based on the results of the above steps a), b).

In further exemplary embodiments, one or more of the following aspects may be used: a) Modeling of a radar transmitter S-ES (position, size, beam angle, beam intensity), see also element 170 according to FIG. 24; b) Modeling of a radar receiver E-ES (position, size, acceptance), see also element 172 according to FIG. 24; or c) Determination of the received intensity of the radar radiation ES taking into account the material data, size and shape of the component OBJ, the received radar intensity can be determined, for example, via beam tracing (ray tracing), Fourier optics or similar methods.

The implementation of autonomous driving is a key issue in the automotive industry, for example. To detect the surroundings and other road users, for example, electromagnetic radiation ES is emitted at a radar frequency and the backscattered radiation is detected. The radar transmitter/receiver system is located, for example, “behind” a painted polymer substrate OBJ′, e.g. a bumper of a motor vehicle. This polymer substrate OBJ′ and its paint layers 11, 12, 13 influence the signal strength of the electromagnetic radiation ES at the (radar) detector.

In order to optimize the radar transmission of such coated polymer substrates OBJ′, their transmission T can be measured, for example based on the principle according to the present embodiments, for example by means of terahertz (THz)-based measurements, e.g. THz spectroscopy.

In further exemplary embodiments, the measurement method is based on a reflection measurement (see e.g. FIG. 11) and can therefore be carried out with any geometry and position of the measuring point MP1, MP2, . . . . Some current methods of radar transmission determination do not allow this flexibility, as the emitter and receiver of conventional systems are mounted on different sides of the polymer substrate. This can be avoided by the method according to exemplary embodiments, and at the same time, according to exemplary embodiments, the THz-based measurement information is applicable, for example, for the coating thickness measurement, for example, with respect to the paint coating system 11, 12, 13.

In further exemplary embodiments, a determination of the substrate layer thickness D-10 presents a challenge in determining the (radar) transmission T. According to investigations by the applicant, on a conventional component OBJ′, for example, a variation of the thickness D-10 of the substrate 10 of 20 μm (micrometers) leads to a variation of the transmission T at a frequency of, for example, 78 GHz of 2%. In further exemplary embodiments, it follows from this that the thickness of a conventional component, which is approximately 3 mm, should be determined with a relative error of 0.7% in order to be able to determine the transmission T with an accuracy of 2%. This is made possible by the method according to exemplary embodiments, for example in a THz-based determination of the thicknesses D-10, D-11, . . .

In further exemplary embodiments, the MOD-SD-1, MOD-SD-2 model used, for example, for determining the layer thicknesses can, for example, also describe further, e.g. instrument-dependent, influences, for example in order to achieve a good adaptation of the measurement results. While in some models according to some exemplary embodiments, e.g. fit models, plane waves are assumed for modeling the propagation of the THz radiation, according to further exemplary embodiments it may be advantageous to perform corrections according to further exemplary embodiments for the typical comparatively large substrate layer thicknesses D-10 of e.g. 2 mm to 3 mm.

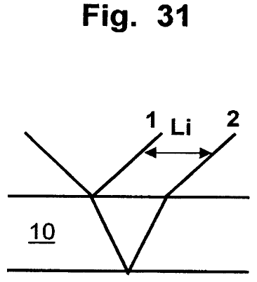

In further exemplary embodiments, according to investigations by the applicant, one, e.g. large, influence on THz-based measurements M-THz is, for example, a focusing of the THz radiation TS, TS-T (FIG. 11), e.g. of a THz pulse, at a comparatively small angle onto the sample. This is illustrated as an example in FIG. 31: The THz beam 2 (“beam 2”) reflected at the rear side experiences a beam offset Li in the imaging optics with respect to the beam 1 reflected at the front side, depending on the layer thickness and the refractive index of the layer (e.g. substrate) 10.

This beam offset can, for example, lead to a lower intensity of the beam 2 reflected at the rear side (which is associated with the second partial signal TS-1-b, FIG. 18), for example in comparison to a plane wave model.

In further exemplary embodiments, it is therefore provided that a model MOD-SD-1, MOD-SD-2 used takes these geometry effects into account, for example. In further exemplary embodiments, this can be done, for example, using the term TS-TERM already described above with reference to FIG. 14, among others, see also, for example, element 135a according to FIG. 10.

In further exemplary embodiments, at least some of the following steps may be performed: a) Determination of the geometry factors; and/or b) Correction of the MOD-SD-2 model.

Determination of the geometry factors includes, e.g., the following: a) Recording THz signals at a reference sheet metal (e.g. THz signals reflected at the reference sheet metal), e.g. by varying the distance D1 between the THz head 20, 25 and the reference plate; and b) The recorded THz signals are used to determine a geometry factor G(D1). The THz spectrum is referenced from the distance D1 to a global reference (e.g. at D1=0).

Correction of the MOD-SD-2 model includes, e.g., the following: The MOD-SD-2 model, which was previously designed, e.g. for plane shafts in other exemplary embodiments, is now corrected with the geometry factors G(D1) corrected. In further exemplary embodiments, for example, each possible back reflection is assigned a specific geometry factor G(D1). This is shown as an example for a single-layer system (e.g. substrate 10, neglecting the paint layers 11, 12, 13), see also the above explanations on the term TS-TERM:

$$H ( ω ) = exp [ - i \frac{ω}{{c}_{0}} ( 2 Δ D ) ( {n}_{A} - i {ϵ}_{A} ) ] \qquad ( 12 )$$

$$\times ( {t}_{A 1} \cdot {t}_{1 A} \cdot {\sum }_{R = 0}^{∞} {r}_{1 S}^{R + 1} \cdot {r}_{1 A}^{R} \cdot G ( D , R , ω ) \cdot exp [ - i \frac{ω}{{c}_{0}} ( 2 R + 2 ) D ( n - i ϵ ) ] + {r}_{A 1} ) / {r}_{AM} \qquad ( 13 )$$

The point is:
H—model-based transfer function
R—Number of reflections
tA1,t1A—Fresnel coefficients of transmission at the air-layer and layer-air transition
rA1,r1A—Fresnel coefficients of reflection at the air-layer and layer-air transition
r1S—Fresnel coefficients of reflection at the interface layer-substrate.

In further exemplary embodiments, the “correct” position Z(D,R) or D1(D, R) and thus, for example, the geometry factor G(Z(D,R)) can be determined from (D,R), cf. also the term TS-TERM described above with reference to FIG. 14.

In further exemplary embodiments, the respective displacement Li (FIG. 31) of the individual layers 11, 12, 13 can be added up for a system OBJ′ with several layers 11, 12, 13.

In further exemplary embodiments, the respective displacement Li, for example in order to determine the corresponding distance z on a reference sheet metal for a layer with the thickness di, is set equal to that on a reference sheet metal. This results in the following equation for the reference position Z in further exemplary embodiments:

$$Z = {\sum }_{i = 1}^{M} \frac{tan ( {θ}_{i} )}{tan ( {θ}_{A} )} {d}_{i} .$$

In other words, the shift in the imaging optics caused by the additional layer is compensated for. The following applies to the displacement Li in further exemplary embodiments:

$${L}_{i} = 2 asin ( \frac{{n}_{A}}{{n}_{i}} sin ( {θ}_{A} ) ) {d}_{i}$$

where θ_{A}, θᵢ characterizes the angle of incidence in air of the layer, where di characterizes the thickness of the layer i, and where M characterizes a number of layers.

In further exemplary embodiments, the following approaches can be used, e.g. as alternatives, for a distance correction (“z-correction”):

In further exemplary embodiments, one or the reason for the distance dependence of the THz signal is the angle α (FIG. 12) of the THz beam.

In further exemplary embodiments, an antenna geometry for the THz transmitter 21 and/or receiver 22 can enable implementation of the transmitter and receiver antenna in a (same) chip. This allows the angle of incidence α to be set to 0°, for example, whereby in further exemplary embodiments a (distance) correction can be dispensed with.

1-28. (canceled)

29. A method for determining a transmission of an object, which comprises at least a substrate, for electromagnetic radiation in a frequency range between 30 GHz (Gigahertz) and 200 GHz, comprising:
determining a thickness of the substrate at least one location of the object for one or more measuring points, using at least one measurement a) based on terahertz radiation, having a terahertz-radiation in a frequency range between 0.1 THz and 6 THz, by means of at least one measurement which is based on an optical and/or a mechanical measuring principle, having a terahertz-radiation in a frequency range between 0.1 THz and 6 THz; and
determining the transmission using a first model characterizing the transmission of the object for the electromagnetic radiation, based at least on the thickness of the substrate.

30. The method according to claim 29, wherein at least one layer is arranged on a first surface of the substrate, the method comprising determining a layer thickness of the at least one layer, at least one location of the object, and determining the transmission using the first model and/or at least one further model which characterizes the transmission of the object for the electromagnetic radiation, based at least on the thickness of the substrate and on the layer thickness of the at least one layer.

32. The method according to claim 30, wherein the thickness of the substrate is at least ten times greater than the layer thickness of the at least one layer.

33. The method according to claim 29, wherein the electromagnetic radiation has frequencies between 76 GHz and 81 GHz.

34. The method according claim 29, further comprising at least one of the following: determining the layer thickness of the at least one layer, for one or more measuring points, using at least one measurement based on terahertz radiation; or determining the thickness of the substrate and the layer thickness of the at least one layer by means of at least one measurement common, to the substrate and the at least one layer, based on terahertz radiation; e) determining the thickness of the substrate, for example for one or more measuring points, based on structural data, of the object, f) determining the thickness of the substrate and/or the at least one layer thickness for one or more measuring points, based on existing thickness respectively layer thickness values of at least one other measuring point.

35. The method according to claim 34, comprising at least one of the following:
a) performing at least one measurement based on reflection of the terahertz radiation; or
b) performing at least one measurement based on transmission of the terahertz radiation.

36. The method according to claim 29, comprising:
providing material data characterizing a propagation of the electromagnetic radiation in the object, in the substrate and/or in the at least one layer, wherein the material data comprises at least one of the following elements: a) dispersion relations, comprising a frequency-dependent and/or constant refractive index, and/or a frequency-dependent and/or constant absorption index, b) surface properties; and
using the material data for determining the transmission.

37. The method according to claim 29, comprising at least one of the following:
a) providing the first model as an object model, which characterizes the transmission based on the thickness of the substrate and/or based on material data associated with the object; or
b) providing the at least one further model, as an object model which characterizes, the transmission based on the thickness of the substrate and a layer thickness of at least one layer and/or based on material data associated with the object, the substrate, and/or the at least one layer.

38. The method according to claim 29, comprising:
taking into account a dependence of a propagation of the terahertz radiation in the object using at least one of the following criteria: a) a distance of a transmitter and/or receiver for the terahertz radiation from the object; b) the thickness of the substrate and/or a layer thickness of at least one layer; or c) an angle (α) between a main beam direction of the terahertz radiation and a surface normal of at least one outer and/or inner interface of the object and/or the substrate.

39. The method according to claim 38, wherein the taking into account comprises:
characterizing, using at least one layer model, a propagation of the terahertz radiation in the region of at least one interface between two media adjoining one another in a spatial region associated with the object, the at least one layer model having a term characterizing the THz radiation, wherein the term is dependent on at least one of the following elements: a) frequency of the terahertz radiation, b) spatial extent and/or position of at least one of the two adjacent media, wherein A) the at least one layer model characterizes at least one reflection and/or transmission of the terahertz radiation at the at least one interface between the at least two media, wherein the at least one layer model characterizes several reflections and/or transmissions of the terahertz radiation at least two interfaces between different media, and/or wherein B) the at least one layer model characterizes one respectively the plurality of reflections and/or transmissions of the terahertz radiation at a plurality of interfaces between in each case two media adjoining one another in the spatial region is characterized using a coherent superposition function, wherein the term being provided as a weighting factor for at least some components of the coherent superposition function.

40. The method according to claim 38, comprising:
determining a first, time-resolved THz signal; and
determining, based on the first THz signal, using at least one temporal windowing, a first partial signal, wherein the first partial signal characterizes THz radiation which a) at a first interface between the at least one layer and the first surface of the substrate has been reflected, b) but has not been reflected at a second surface of the substrate opposite the first surface of the substrate.

41. The method according to claim 40, comprising:
determining a second partial signal, wherein the second partial signal characterizes THz radiation which has been reflected at a second interface opposite the first interface, wherein a second surface of the substrate opposite the first surface of the substrate forms the second interface.

42. The method according to claim 40, comprising:
determining the layer thickness of the at least one layer based on the first partial signal using a or the first layer model for the at least one layer.

43. The method according to claim 40, comprising:
determining the thickness of the substrate based on the first THz signal, wherein determining the thickness of the substrate based on the first THz signal comprises at least one of the following elements: a) determining the thickness of the substrate based on a high-frequency component of a transfer function associated with the first THz signal, b) determining the thickness of the substrate based on a linear phase which characterizes a difference of a phase of a transfer function associated with the second partial signal and a phase of a transfer function associated with the first partial signal.

44. The method according to claim 29, comprising:
determining the layer thickness of the at least one layer and the thickness of the substrate based on the first THz signal, using a second layer model for the substrate with the at least one layer.

45. The method according to claim 29, comprising:
determining the transmission for at least one measuring point of the object, and/or determining the transmission for a plurality of measuring points of the object.

46. The method according to claim 45, comprising:
determining whether a complexity of the object exceeds a predeterminable limit value, and
when the complexity does not exceed the predeterminable limit value, determining the transmission based on a plurality of measurement points based on averaging with respect to the plurality of measurement points; and
when the complexity exceeds the predeterminable limit value, determining the transmission using a design model of the object, wherein the design model characterizes at least one surface structure and/or coating of the object, and adapting the design model to a measured substrate thickness and/or layer thickness for one or more measuring points.

47. The method according to claim 29, comprising: modeling a transmitter emitting the electromagnetic radiation with respect to at least one of the following elements: a) position, b) size, c) emission angle or characteristic, d) emission intensity.

48. The method according to claim 29, comprising:
modeling a receiver receiving the electromagnetic radiation with respect to at least one of the following elements: a) position, b) size, c) receiving characteristic.

49. The method according to claim 29, comprising:
providing an overall model for the transmission based on an object model for the object, and on at least one further model, wherein the at least one further model characterizes a transmitter and/or a receiver of the electromagnetic radiation;
configuring the overall model based on the transmission determined for at least one measuring point of the object, and/or based on determined layer thicknesses and/or substrate thicknesses and/or based on at least one frequency-dependent and/or constant refractive index and/or based on at least one frequency-dependent and/or constant absorption index;
evaluating the overall model; and
adjusting at least one component of the overall model.

50. The method according to claim 49, comprising:
determining a received intensity of the electromagnetic radiation, wherein, the evaluating and/or the determining is performed based on a ray tracing method and/or a calculation method for the propagation of the electromagnetic radiation.

51. The device for carrying out the method according to claim 29, comprising at least one of the following elements: a) an interface port to at least one THz measuring system which is designed to transmit and/or receive terahertz radiation, wherein the THz measuring system having at least one transmitter and a receiver for the terahertz radiation and/or a transceiver for the terahertz radiation, b) a positioning system.

52. The device according of claim 51, wherein the device is used for at least one of the following: a) determining a transmission of an object in a radar frequency range based on a thickness measurement of at least one component of the object, b) determining a transmission of an object in a radar frequency range based on a thickness measurement based on the use of THz radiation of at least one component of the object, c) determining a transmission of an object in a radar frequency range based on reflection measurements using THz radiation; d) adapting a design model, of the object, e) determining a transmission of an object in a radar frequency range and of a thickness of the substrate and/or at least one layer thickness of the at least one layer based on at least one THz-based measurement.
